(19) United States
(12) Patent Application Publication
(10) Pub. No.: US 2024/0298092 A1
(43) Pub. Date: Sep. 5, 2024

(54) DIMMING APPARATUS AND IMAGING APPARATUS

(71) Applicant: Panasonic Intellectual Property Management Co., Ltd., Osaka (JP)

(72) Inventors: Shoichi YOKOI, Osaka (JP); Michio KISHIBA, Osaka (JP)

(73) Assignee: Panasonic Intellectual Property Management Co., Ltd., Osaka (JP)

(21) Appl. No.: 18/436,101

(22) Filed: Feb. 8, 2024

(30) Foreign Application Priority Data
Mar. 2, 2023 (JP) 2023-032215

(51) Int. Cl. H04N 23/75; H04N 23/72; H04N 23/73; H04N 23/81

(52) U.S. Cl. CPC H04N 23/75; H04N 23/72; H04N 23/73; H04N 23/81

(57) ABSTRACT

A dimming apparatus includes: a dimming element that adjusts an amount of light reaching an imaging element from a subject at a time of imaging according to an applied voltage; a driver that applies a drive voltage to be inverted to the dimming element; and a controller that controls the driver. The controller controls the driver to change a drive frequency of the drive voltage according to a preset length of an exposure time of the imaging element.

### CROSS REFERENCE TO RELATED APPLICATION

This application claims priority to Japanese Patent Application 2023-032215 filed on Mar. 2, 2023, the content of which are incorporated herein by reference.

### BACKGROUND

### Technical Field

The present disclosure relates to a dimming apparatus and an imaging apparatus.

### Background Art

WO 2017/061169 A discloses an imaging apparatus including a lens, an imaging element provided on an optical axis of the lens, and a dimming element provided between the lens and the imaging element. The dimming element adjusts the amount of light from the lens toward the imaging element. Furthermore, the imaging apparatus of WO 2017/061169 A includes: a liquid crystal dimming element in which a plurality of liquid crystal layers sandwiched between two electrodes serving as both end electrodes are arranged side by side in an optical axis direction of transmitted light; and a dimming drive unit that gives a drive signal inverted at a predetermined period to both the end electrodes of each liquid crystal layer to the liquid crystal dimming element, and causes each drive signal to be a signal having a phase shifted from an in-phase or anti-phase relationship. WO 2017/061169 A describes that with the above configuration, the inversion timing of each liquid crystal layer of the liquid crystal dimming element can be dispersed from the inversion timing of the frequency of the AC drive signal, and the degradation of the quality of the captured image can be reduced.

### SUMMARY

An object of the present disclosure is to provide a dimming apparatus and an imaging apparatus capable of further reducing an influence of a drive voltage to be inverted on image quality.

A dimming apparatus according to an aspect of the present disclosure includes: a dimming element that adjusts an amount of light reaching an imaging element from a subject at the time of imaging according to an applied voltage; a driver that applies a drive voltage to be inverted to the dimming element; and a controller that controls the driver, in which the controller controls the driver to change a drive frequency of the drive voltage according to a preset length of an exposure time of the imaging element.

An imaging apparatus according to an aspect of the present disclosure includes: the above-described dimming apparatus; and an imaging element that captures an image of a subject and generates image data.

According to the present disclosure, it is possible to provide the dimming element and the imaging apparatus capable of further reducing the influence of the drive voltage to be inverted on the image quality.

### BRIEF DESCRIPTION OF DRAWINGS

FIG. 1 is a block diagram illustrating a configuration of a digital camera according to a first embodiment;

FIG. 2 is a schematic diagram for explaining a configuration example of a dimming element and a principle of dimming;

FIG. 3 is a schematic diagram for explaining a configuration example of a dimming element and a principle of dimming;

FIG. 4 is a schematic diagram for explaining a relationship between an exposure time and a timing of inversion of a drive voltage for each line of an image sensor in a case where a dimming apparatus is driven at a high frequency;

FIG. 5 is a schematic diagram illustrating a captured image when an exposure time is short in a case of high-frequency driving;

FIG. 6 is a schematic diagram illustrating a captured image when the exposure time is long in the case of high-frequency driving;

FIG. 7A is a schematic diagram for explaining a relationship between an exposure time and a timing of inversion of a drive voltage in a case where the exposure time is long, for each line of the image sensor in a case where the dimming apparatus is driven at a low frequency;

FIG. 7B is a schematic diagram for explaining a relationship between the exposure time and the timing of inversion of the drive voltage in a case where the exposure time is short, for each line of the image sensor in the case where the dimming apparatus is driven at a low frequency;

FIG. 8 is a schematic diagram illustrating a captured image when an exposure time is long in a case of low-frequency driving;

FIG. 9 is a schematic diagram illustrating a captured image when the exposure time is short in the case of low-frequency driving;

FIG. 10 is a flowchart illustrating dimming processing according to the first embodiment;

FIG. 11 is a flowchart illustrating dimming processing according to a second embodiment;

FIG. 12 is a flowchart illustrating processing in a live-view mode in FIG. 11;

FIG. 13 is a flowchart illustrating processing in a still image shooting mode in

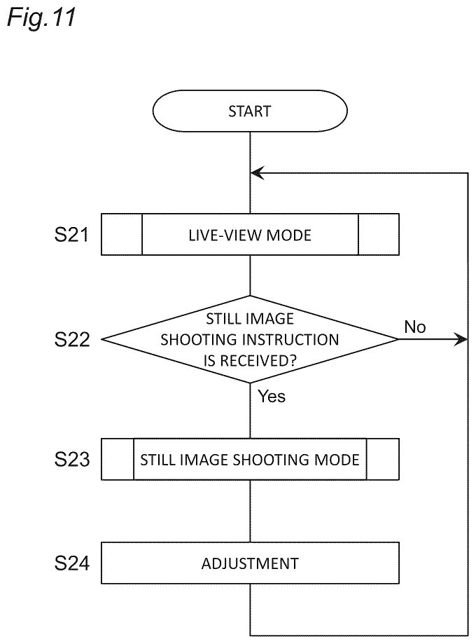

FIG. 11;

FIG. 14 is a timing chart for explaining control of a drive voltage in dimming processing according to the second embodiment;

FIG. 15 is a timing chart for explaining control of a drive voltage in dimming processing according to the second embodiment;

FIG. 16 is a timing chart for explaining control of a drive voltage in dimming processing according to the second embodiment;

FIG. 17 is a schematic diagram illustrating a configuration of a dimming element according to a second modification;

FIG. 18 is a schematic diagram for explaining a relationship between an exposure time and a timing of inversion of a drive voltage for each line of an image sensor of a global shutter method according to a fourth modification; and

FIG. 19 is a schematic diagram for explaining a relationship between an exposure time and a timing of inversion of a drive voltage for each line of an image sensor of a method using a focal plane shutter according to a seventh modification as a light shielding element.

### DETAILED DESCRIPTION

Hereinafter, embodiments will be described with reference to the drawings as appropriate. However, unnecessarily detailed description may be omitted. For example, detailed description of already well-known matters and overlapping description for substantially the same configuration may be omitted. This is to avoid the following description from becoming unnecessary redundant and to facilitate understanding by those skilled in the art.

Note that the inventor(s) provides the accompanying drawings and the following description in order for those skilled in the art to fully understand the present disclosure, and does not intend to limit the subject matter described in the claims by the accompanying drawings and the following description.

### 1. First Embodiment

### 1-1. Configuration

### 1-1-1. Configuration Example of Digital Camera

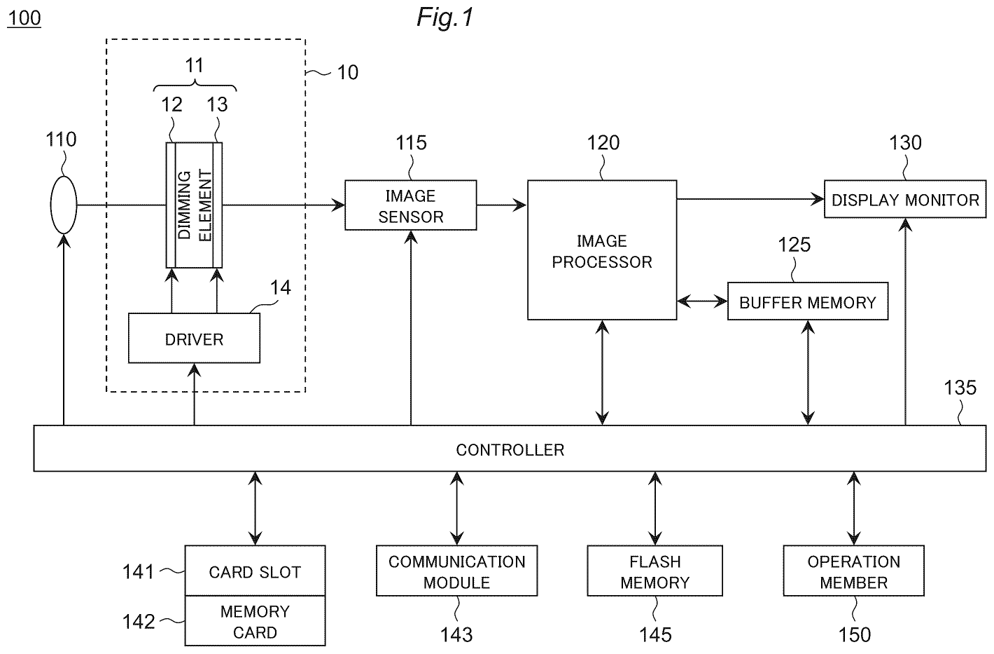

FIG. 1 is a block diagram illustrating a configuration of a digital camera 100 (an example of an imaging apparatus) according to a first embodiment of the present disclosure. The digital camera 100 includes an optical system 110, a dimming apparatus 10, an image sensor 115, an image processor 120, a buffer memory 125, a display monitor 130, and a controller 135. The digital camera 100 further includes a card slot 141, a communication module 143, a flash memory 145, and an operation member 150.

The optical system 110 includes a focus lens, a zoom lens, an optical image stabilization (OIS) lens, an aperture, a shutter, and the like. The various lenses included in the optical system 110 include one or more lenses.

The dimming apparatus 10 includes a dimming element 11 and a driver 14 that applies an AC drive voltage to the dimming element 11. The AC drive voltage is an example of a “drive voltage to be inverted” in the present disclosure. The drive voltage to be inverted is a drive voltage whose positive and negative are inverted regularly or irregularly. In the present disclosure, a configuration further including not only the dimming element 11 and the driver 14 but also the controller 135 or a portion having a dimming control function in the controller 135 may be referred to as a dimming apparatus.

The dimming element 11 adjusts the amount of light reaching the image sensor 115 from a subject at the time of imaging according to the magnitude of the drive voltage. The dimming element 11 is disposed between the subject and the image sensor 115. For example, the dimming element 11 is disposed between the optical system 110 and the image sensor 115. In the present embodiment, the dimming element 11 includes liquid crystal elements 12 and 13. Details of the dimming apparatus 10 will be described later.

The image sensor 115 captures a subject image formed via the optical system 110 to generate image data. The image data includes moving image data, still image data, and live-view image data. The live-view image indicated by the live-view image data is mainly a moving image, and is an image displayed on the display monitor 130 in real time. A user can check the situation of the subject by referring to the live-view image, and thus, for example, can determine the composition of the shot image.

The image sensor 115 generates image data of a new frame at a predetermined frame rate (for example, 24 frames per second (fps), 30 fps, 60 fps, etc.). As the image sensor 115, various image sensors such as a CMOS image sensor, a CCD image sensor, or an NMOS image sensor may be used. The image sensor 115 is an example of an imaging element in the present embodiment.

The pixels of the image sensor 115 are arranged in a two-dimensional array. For example, the image sensor 115 includes a plurality of one-dimensional sensor arrays (lines) arranged in a vertical direction. In each line, a plurality of pixels is arranged in the horizontal direction.

The image processor 120 performs predetermined processing on image data output from the image sensor 115 or image data read from a memory card 142. The processed image data is displayed on, for example, the display monitor 130 or stored in the memory card 142, the flash memory 145, or the like. Examples of the predetermined processing include white balance correction, gamma correction, YC conversion processing, electronic zoom processing, compression processing, expansion processing, and the like, but are not limited to these. The image processor 120 may be configured by a hardwired electronic circuitry, or may be configured by a microcomputer using a program.

The display monitor 130 is a display device such as a liquid crystal display or an organic EL display capable of displaying information. For example, the display monitor 130 displays an image indicated by the image data processed by the image processor 120. In addition, the display monitor 130 displays a menu screen for a user to confirm the setting of the digital camera 100.

The controller 135 controls the overall operation of the digital camera 100. The controller 135 may include a processor or a circuitry configured to realize a predetermined function by executing a program. For example, the controller 135 can be realized with various processors such as a CPU, an MPU, a GPU, a DSP, an FPGA, and an ASIC. The controller 135 may include one or more processors. Furthermore, the controller 135 may include one semiconductor chip together with the image processor 120, the buffer memory 125, and the like.

The buffer memory 125 is a recording medium that functions as a work memory for the image processor 120 and the controller 135. The buffer memory 125 is realized by a dynamic random access memory (DRAM) or the like. The flash memory 145 is a non-volatile recording medium. Each of the memories 125 and 145 is an example of a storage in the present embodiment.

The memory card 142 is detachably inserted into the card slot 141. The card slot 141 enables electrical and mechanical connection with the memory card 142. The memory card 142 is an external memory having a recording element such as a flash memory inside. The memory card 142 can store information such as image data generated by the image processor 120.

The communication module 143 performs data communication according to an existing wired communication standard or wireless communication standard. For example, the digital camera 100 can communicate with a communication network such as the Internet, an external device, or the like via the communication module 143. The digital camera 100 may communicate directly with other devices via the communication module 143 or may communicate with other devices via an access point.

The operation member 150 is a generic name of a user interface that accepts an operation by a user. The operation member 150 includes, for example, a button such as a release button, a lever, a mode dial, a touch panel, and a switch. The operation member 150 is not limited to a hardware key, and may include, for example, a software key such as a virtual button displayed on the display monitor 130. When the operation member 150 receives an operation by the user, the operation member 150 transmits an operation signal corresponding to the user operation to the controller 135.

### 1-1-2. Configuration Example of Dimming Element

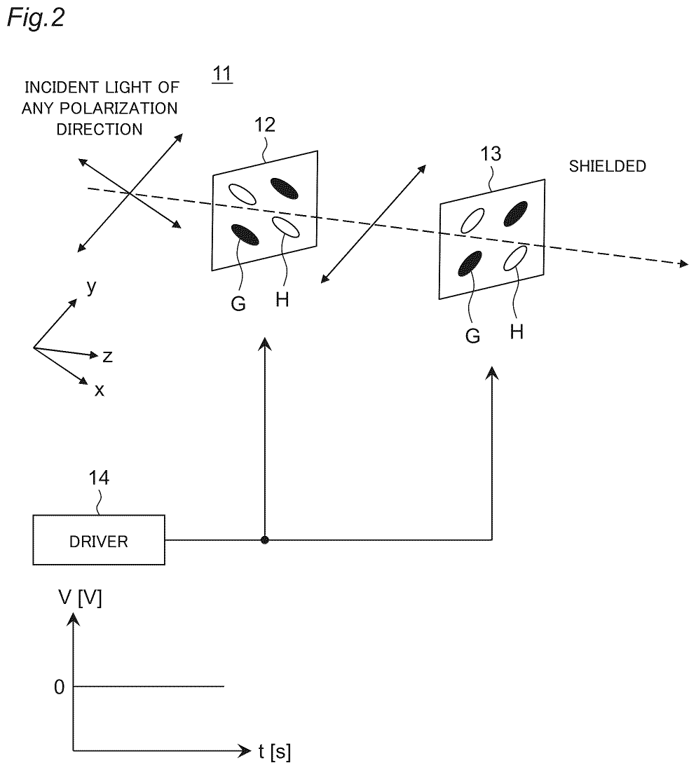

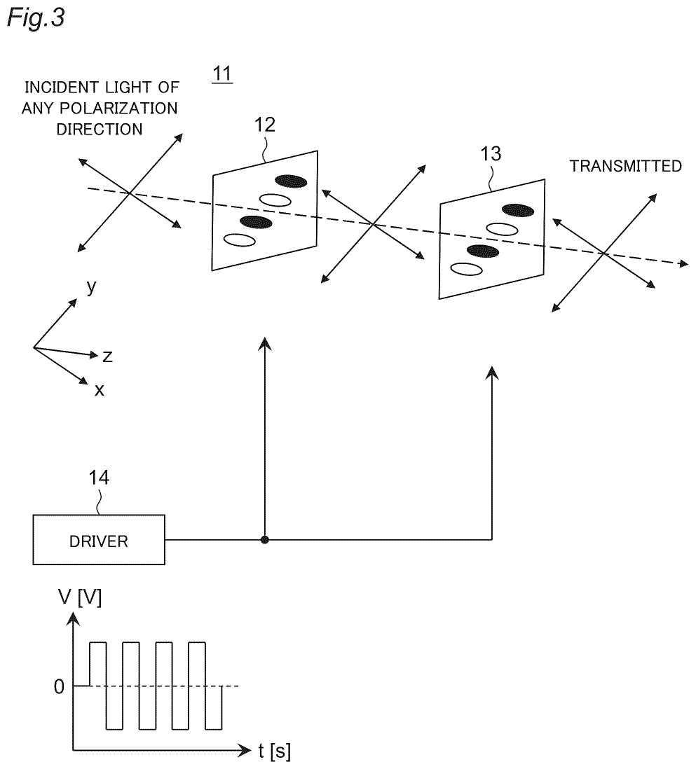

FIGS. 2 and 3 are schematic diagrams for explaining a configuration example of the dimming element 11 and the principle of dimming. The dimming element 11 shields incident light in the state illustrated in FIG. 2 and transmits the incident light in the state illustrated in FIG. 3. For convenience of explanation, FIGS. 2 and 3 illustrate virtual x, y, and z axes orthogonal to each other. The direction of the z axis substantially coincides with the direction of the optical path of the optical system 110 in the digital camera 100 in FIG. 1.

Each of the liquid crystal elements 12 and 13 is a guest-host liquid crystal element containing dichroic dye molecules (guest) G and liquid crystal molecules (host) H. In order to receive supply of a drive voltage V from the driver 14, each of the liquid crystal elements 12 and 13 is sandwiched between electrodes (not illustrated). This configuration has four electrodes.

Alternatively, both the liquid crystal elements 12 and 13 may be sandwiched between a pair of electrodes. This configuration has two electrodes.

The dichroic dye molecules G are aligned in the same direction as the liquid crystal molecules H. In FIG. 2, no voltage is applied to the liquid crystal elements 12 and 13 (the drive voltage V is 0). In a state where no voltage is applied, the dichroic dye molecules G and the liquid crystal molecules H of the liquid crystal element 12 are aligned in the x direction, and the dichroic dye molecules G and the liquid crystal molecules H of the liquid crystal element 13 are aligned in the y direction.

When incident light of any polarization direction are incident on the liquid crystal element 12 to which no voltage is applied, a portion of the incident light polarized in the x direction is shielded by the dichroic dye molecules G of the liquid crystal element 12. Therefore, only a portion of the incident light polarized in the y direction is transmitted through the liquid crystal element 12. The y-polarized light is shielded by the dichroic dye molecules G of the liquid crystal element 13 aligned in the y direction, and cannot be transmitted through the liquid crystal element 13. Therefore, in a state where no voltage is applied, the incident light is shielded by the liquid crystal elements 12 and 13 (normally black).

As illustrated in FIG. 3, when the drive voltage V is applied by the driver 14, the alignment of the liquid crystal molecules H of the liquid crystal elements 12 and 13 changes in the z direction, and accordingly, the alignment of the dichroic dye molecules G also changes in the z direction. When the alignment of the dichroic dye molecules G of the liquid crystal elements 12 and 13 is in the z direction, the incident light can be transmitted through the liquid crystal elements 12 and 13. In this manner, the controller 135 that controls the driver 14 can control the transmittance of the dimming element 11 including the liquid crystal elements 12 and 13.

When a DC voltage is applied to the liquid crystal element, the liquid crystal element is deteriorated due to the bias of positive and negative charges, and the life of the liquid crystal element is shortened. In order to prevent this, a technology of applying an AC drive voltage to a liquid crystal element is known. FIG. 3 also illustrates an example in which the drive voltage V is an alternating current.

When the drive voltage V is AC, a phenomenon (blinking) in which the amount of light transmitted through the dimming element 11 changes at the timing of inversion of the drive voltage V occurs. For example, the transmittance of the dimming element 11 becomes lower than the intended transmittance (transmittance in a period other than the timing of inversion) at the timing of inversion of the drive voltage V. Therefore, streaks, unevenness, and the like occur in the captured image, which may affect the image quality.

### 1-2. Influence of AC Drive Voltage on Image Quality

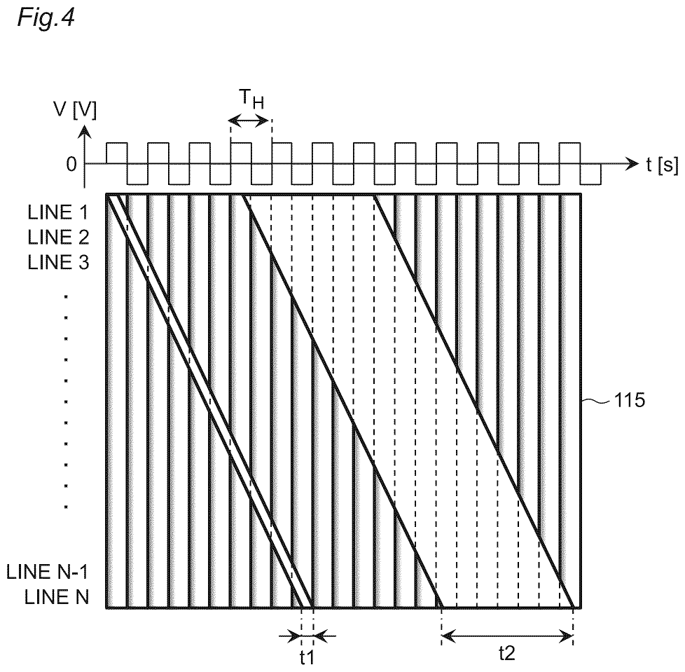

Hereinafter, the presence or absence of the influence of the AC drive voltage V on the image quality and the degree thereof will be described with reference to FIGS. 4 to 9.

### 1-2-1. In Case of High-frequency Driving

FIG. 4 is a schematic diagram for explaining a relationship between an exposure time and a timing of inversion of the drive voltage V for each line of the image sensor 115 in a case where the dimming apparatus 10 is driven at a high frequency. In the example illustrated in FIG. 4, the image sensor 115 includes N (N is an integer of 2 or more) one-dimensional sensor arrays (lines) arranged in the vertical direction. In FIG. 4, the fact that the incident light reaching the image sensor 115 decreases at the timing of inversion of the drive voltage V is indicated by a stripe pattern or a dashed line extending in the vertical direction.

Two quadrangles superimposed and displayed on the image sensor 115 indicate the exposure timing of each line when a rolling shutter method is adopted. The rectangle on the left side indicates the exposure timing of each line when the exposure time is t1 (the exposure time is short), and the rectangle on the right side indicates the exposure timing of each line when the exposure time is t2 (>t1) (the exposure time is long). In the rolling shutter method illustrated in FIG. 4, the image sensor 115 is sequentially exposed downward from the upper line.

The exposure time is set by the user before shooting, for example. The user can select whether the exposure time is t1 or t2. Alternatively, the exposure time may be automatically set by the controller 135 according to an environment such as ambient brightness.

For example, the exposure time t1 in FIG. 4 is shorter than a predetermined time threshold tₜₕ, and the exposure time t2 is equal to or longer than the time threshold tₜₕ. The time threshold value tₜₕ is set to, for example, 4T_{H} or more, for example, 6T_{H}, 8T_{H}, or the like, but is not limited thereto. Here, T_{H} is a period of the drive voltage V in the case of high-frequency driving. In the case of high-frequency driving, the drive frequency f_{H} of the drive voltage V is, for example, 1 to 10 kHz, and T_{H} is 1/f_{H}.

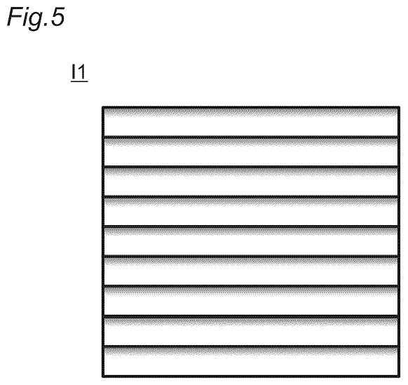

FIG. 5 is a schematic diagram illustrating a captured image I1 when the exposure time is short (for example, the exposure time is t1 in FIG. 4) in the case of high-frequency driving. In the captured image I1, the influence of blinking due to the inversion of the drive voltage V appears as a streak or a stripe extending in the horizontal direction. As described above, in the case of high-frequency driving, when the exposure time is short, the influence of the blinking due to the inversion of the drive voltage V appears relatively remarkably in the captured image I1.

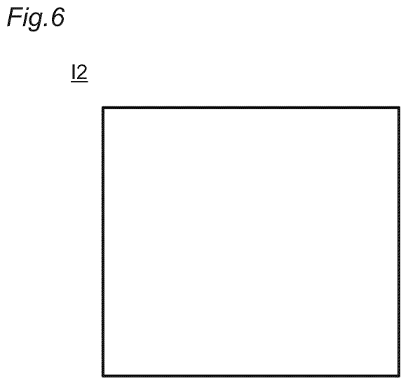

FIG. 6 is a schematic diagram illustrating a captured image I2 when the exposure time is long (for example, the exposure time is t2 in FIG. 4) in the case of high-frequency driving. When the exposure time is long in the case of high-frequency driving, the sum of periods (portions indicated by dashed lines in FIG. 4) in which the influence of the inversion of the drive voltage V occurs is substantially equal in each line. Therefore, in the captured image I2 in FIG. 6, unlike FIG. 5, the difference in brightness between the lines does not remarkably appear.

Therefore, in the present embodiment, when the exposure time is longer than the predetermined time threshold tₜₕ, the controller 135 controls the driver 14 to set the drive frequency of the drive voltage V to be higher than the predetermined frequency fₜₕ. Here, the predetermined frequency fₜₕ is, for example, 1 to 10 kHz. As a result, the influence of the AC drive voltage V on the image quality can be reduced.

### 1-2-2. In Case of Low-frequency Driving

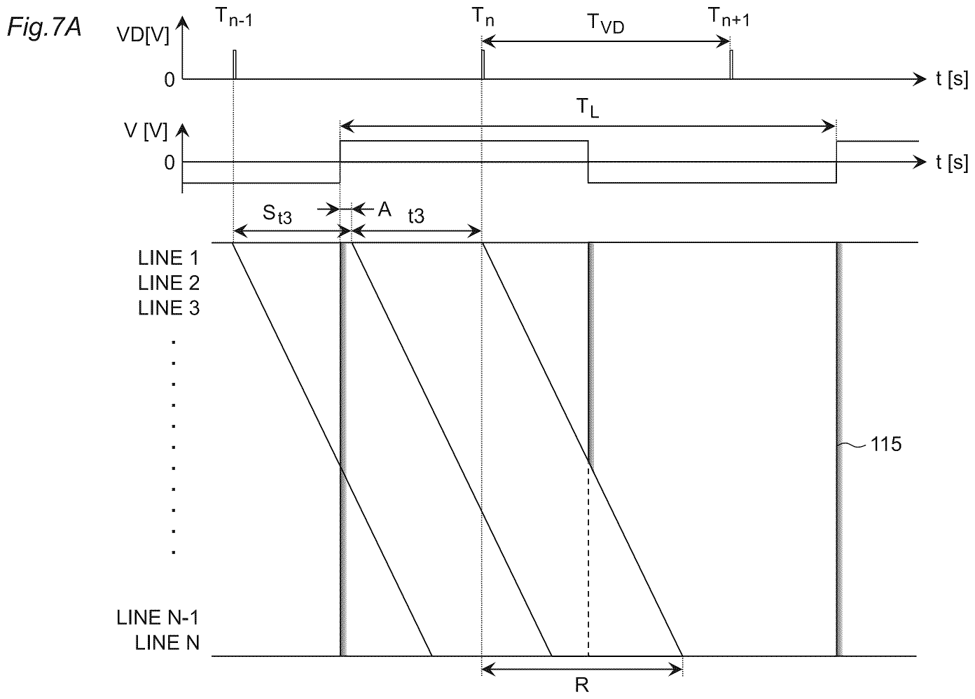

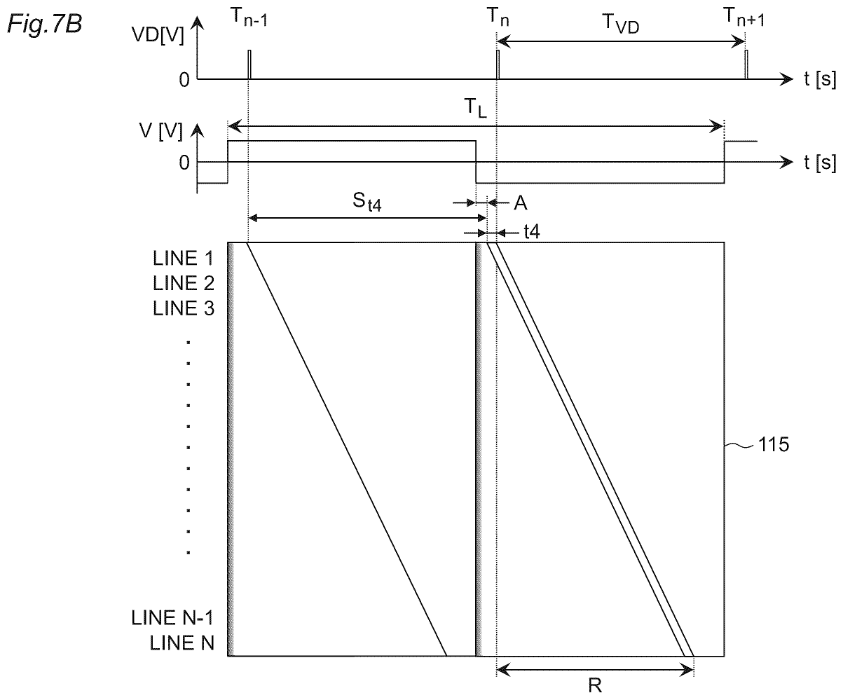

FIGS. 7A and 7B are schematic diagrams for explaining a relationship between an exposure time and a timing of inversion of the drive voltage V for each line of the image sensor 115 in a case where the dimming apparatus 10 is driven at a low frequency.

The exposure of the exposure time t3 (see FIG. 7A) or t4 (see FIG. 7B) is read by the controller 135 to the image processor 120 from a vertical synchronization signal VD of the image sensor 115 at the time Tn over a read time R. The controller 135 sets a non-accumulation time St3 or St4 of the image sensor 115 in the image sensor 115 by a time Tn−1. In general, an image sensor is mounted with a photodiode, and charges accumulated in the photodiode during a non-accumulation time are discharged to a substrate of the image sensor by an electronic shutter pulse to adjust an exposure time. The non-accumulation time St3 in FIG. 7A is a time interval obtained by subtracting the exposure time t3 from an output time interval T_{VD} of the vertical synchronization signal VD of the image sensor 115. The non-accumulation time St4 in FIG. 7B is a time interval obtained by subtracting the exposure time t4 from an output time interval T_{VD} of the vertical synchronization signal VD of the image sensor 115.

The time of inversion of the drive voltage V is preceded by a preceding time A with respect to the exposure time t3 or t4. The preceding time A is a time interval for avoiding blinking due to the inversion of the drive voltage V, and is set to, for example, 0.5 T_{H}.

In the case of low-frequency driving, the drive frequency f_{L} of the drive voltage V is, for example, 10 to 100 Hz, and a cycle T_{L} of the drive voltage V is 1/f_{L}. The exposure time t3 in FIG. 7A is equal to or longer than the time threshold value tₜₕ, and the exposure time t4 in FIG. 7B is shorter than the time threshold value tₜₕ.

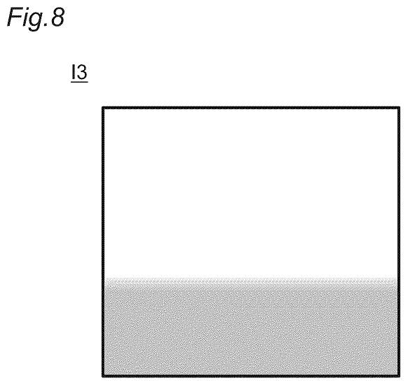

FIG. 8 is a schematic diagram illustrating a captured image I3 when the exposure time is long in the case of low-frequency driving. The case where the exposure time is long in the case of low-frequency driving is, for example, a case where the exposure time is t3 in FIG. 7A, a case where the exposure time or the read time R and the timing of inversion of the drive voltage V overlap with each other, or the like. An example of a case where the exposure time or the read time R and the timing of inversion of the drive voltage V overlap with each other is a case where the sum of the exposure time, the read time R, and the preceding time A is T_{L}/2 or more.

In the captured image I3 in FIG. 8, the influence of the blinking due to the inversion of the drive voltage V appears. When the exposure time is long, an image with high brightness is obtained, whereas in the case of low-frequency driving, the influence of blinking due to the inversion of the drive voltage V appears relatively remarkably in the captured image I3 as illustrated in FIG. 8.

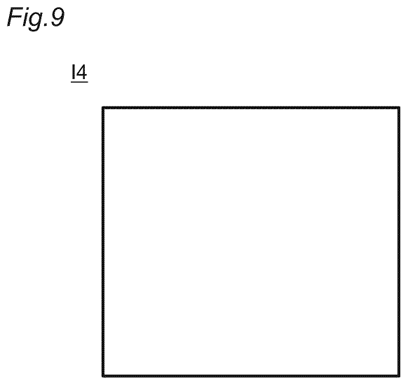

FIG. 9 is a schematic diagram illustrating a captured image I4 when the exposure time is short (for example, the exposure time is t4 in FIG. 7B) in the case of low-frequency driving. As described above, in a case where the exposure time or the read time R and the timing of inversion of the drive voltage V do not overlap with each other, in the captured image I4, the difference in brightness between the lines does not remarkably appear unlike in FIG. 8.

Therefore, in the present embodiment, when the exposure time is shorter than the predetermined time threshold tₜₕ, the controller 135 controls the driver 14 to set the drive frequency of the drive voltage V to f_{L} to be lower than the predetermined frequency fₜₕ. As a result, the influence of the AC drive voltage V on the image quality can be reduced.

Furthermore, in the present embodiment, the controller 135 synchronizes the low-frequency drive voltage V with the drive signal of the image sensor 115, for example, the vertical synchronization signal VD in order to prevent the exposure time or the read time R and the timing of inversion of the drive voltage V from overlapping with each other. As a result, as illustrated in FIG. 7B, the possibility that the exposure is started immediately after the timing of the inversion of the drive voltage V, and the exposure time or the read time R and the timing of inversion of the drive voltage V overlap with each other can be reduced.

### 1-3. Operation

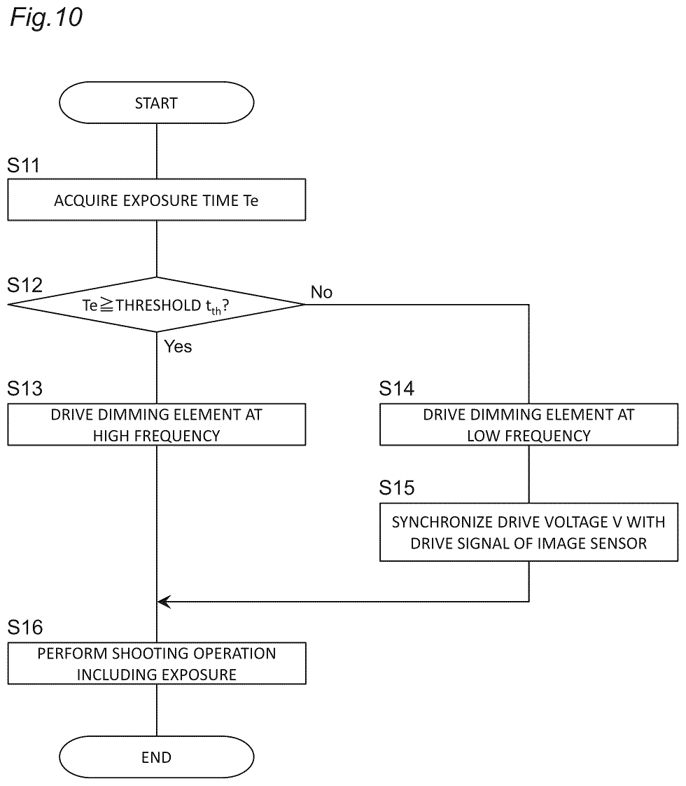

FIG. 10 is a flowchart illustrating dimming processing according to the present embodiment. This processing is executed by the controller 135, for example, every time an exposure time Te is set or changed.

First, the controller 135 acquires the set exposure time Te (S11). For example, when the user selects a desired exposure time using the operation member 150 before shooting, the controller 135 sets the exposure time Te based on the user's selection. Alternatively, the controller 135 may set the exposure time Te according to an environment such as ambient brightness.

Next, the controller 135 determines whether the exposure time Te is equal to or longer than the time threshold tₜₕ (S12).

When the exposure time Te is equal to or longer than the time threshold tₜₕ (Yes in S12), the controller 135 drives the dimming element 11 at a high frequency (S13). For example, the controller 135 controls the driver 14 to set the drive frequency of the drive voltage V to be higher than the predetermined frequency fₜₕ. As a result, the influence of the AC drive voltage V on the image quality can be reduced.

When the exposure time Te is shorter than the time threshold tₜₕ in step S12 (No in S12), the controller 135 drives the dimming element 11 at a low frequency (S14). For example, the controller 135 controls the driver 14 to set the drive frequency of the drive voltage V to be lower than the predetermined frequency fₜₕ.

In the case of the low-frequency drive, the controller 135 synchronizes the drive voltage V with the drive signal of the image sensor 115 (S15). For example, the controller 135 synchronizes at least one of the rise and fall of the drive voltage V with the rise or fall of the vertical synchronization signal VD of the image sensor 115. As a result, as illustrated in FIG. 7B, the possibility that the exposure is started immediately after the timing of the inversion of the drive voltage V, and the exposure time or the read time R and the timing of inversion of the drive voltage V overlap with each other can be reduced.

Here, synchronizing a first signal with a second signal includes not only making the rising or falling time of the first signal completely coincide with the rising or falling time of the second signal, but also changing the second signal a predetermined time after or before the change of the first signal. In the present embodiment, for example, the drive voltage V may be inverted a predetermined time before or after the rise of the vertical synchronization signal VD, or the vertical synchronization signal VD may rise a predetermined time before or after the inversion timing of the drive voltage V.

After step S13 or S15, the controller 135 performs a shooting operation including exposure and reading (S16). In the shooting operation in a case where the drive voltage V is driven at a low frequency, the controller 135 may set the output time interval T_{VD} (see FIGS. 7A and 7B) of the vertical synchronization signal VD of the image sensor 115 to be longer than the sum of the read time R and the exposure time Te of the image sensor 115. As a result, it is possible to prevent the exposure time or the read time from overlapping with the timing of inversion of the drive voltage V.

The controller 135 displays image data generated by the image sensor 115 and the image processor 120 on the display monitor 130 or stores the image data in the memory card 142, the flash memory 145, or the like.

### 1-4. Effects, etc.

As described above, the dimming apparatus 10 according to the present embodiment includes the dimming element 11 that adjusts the amount of light reaching the image sensor 115 from the subject at the time of imaging according to the applied voltage, the driver 14 that applies the AC drive voltage V to the dimming element 11, and the controller 135 that controls the driver 14. The controller 135 controls the driver 14 to change the drive frequency of the drive voltage V according to the preset length of the exposure time Te of the image sensor 115. As a result, the influence of the AC drive voltage V on the image quality can be reduced.

The controller 135 may increase the drive frequency as the exposure time Te is longer. For example, the controller 135 sets the drive frequency of the drive voltage V to be higher than the predetermined frequency fₜₕ when the exposure time Te is equal to or longer than the predetermined time tₜₕ, and sets the drive frequency to be equal to or lower than the predetermined frequency fₜₕ when the exposure time Te is shorter than the predetermined time tₜₕ. When the exposure time is long in a case where the drive frequency is high, the sum of the periods in which the influence of the inversion of the drive voltage V occurs is substantially equal in each line of the image sensor 115. Therefore, the influence of the AC drive voltage V on the image quality can be reduced.

The controller 135 may synchronize the drive voltage V with the drive signal of the image sensor 115. As a result, it is possible to reduce the possibility that the exposure time or the read time overlaps with the timing of inversion of the drive voltage V.

The controller 135 may change the drive voltage V before or after a predetermined time of the change of the drive signal of the image sensor 115. As a result, it is possible to reduce the possibility that the exposure time or the read time overlaps with the timing of inversion of the drive voltage V.

The controller 135 may set the output time interval T_{VD} of the drive signal of the image sensor 115 to be longer than the sum of the read time R and the exposure time Te of the image sensor 115. As a result, it is possible to reduce the possibility that the exposure time or the read time overlaps with the timing of inversion of the drive voltage V.

### 2. Second Embodiment

In a second embodiment, the controller 135 can switch between a live-view mode in which a live-view image is displayed on the display monitor 130 and a still image shooting mode. For example, the user can determine the composition by referring to the live-view image displayed on the display monitor 130, and can shift to the still image shooting mode by pressing the release button to perform still image shooting and saving.

The live-view image displayed on the display monitor 130 in real time may not be required to have high image quality for composition confirmation by the user. In such a case, by partially reading the signals of the pixels of the image sensor 115, the total read time can be shortened. On the other hand, in a case where a still image is captured, signals of all pixels of the image sensor 115 may be read, or the degree of thinning out pixels to be read may be more conservative than in a case of a live-view image. Therefore, there is a possibility that the sum of the read time becomes long, the sum of the read time, the exposure time, and the preceding time A becomes longer than T_{L}/2, and the exposure time or the read time R and the timing of inversion of the drive voltage V overlap with each other.

In the second embodiment, when the exposure time is shorter than the predetermined time threshold value in the still image shooting mode, the drive voltage V is fixed to the predetermined value. Therefore, the drive voltage V is not inverted during the exposure and reading at the time of shooting the still image, and thus, it is possible to reduce the influence of the inversion of the drive voltage V on the image quality.

FIG. 11 is a flowchart illustrating dimming processing according to the second embodiment. The controller 135 operates the digital camera 100 and the dimming apparatus 10 in a live-view mode S21. When receiving a still image shooting instruction (S22), the controller 135 shifts to a still image shooting mode S23.

When the still image shooting in the still image shooting mode S23 is completed, the controller 135 adjusts the timing of the vertical synchronization signal VD (S24), and then returns to the live-view mode S21. The adjustment step S24 is performed, for example, to synchronize the vertical synchronization signal VD with the frame rate (for example, 60 fps) of the display monitor 130.

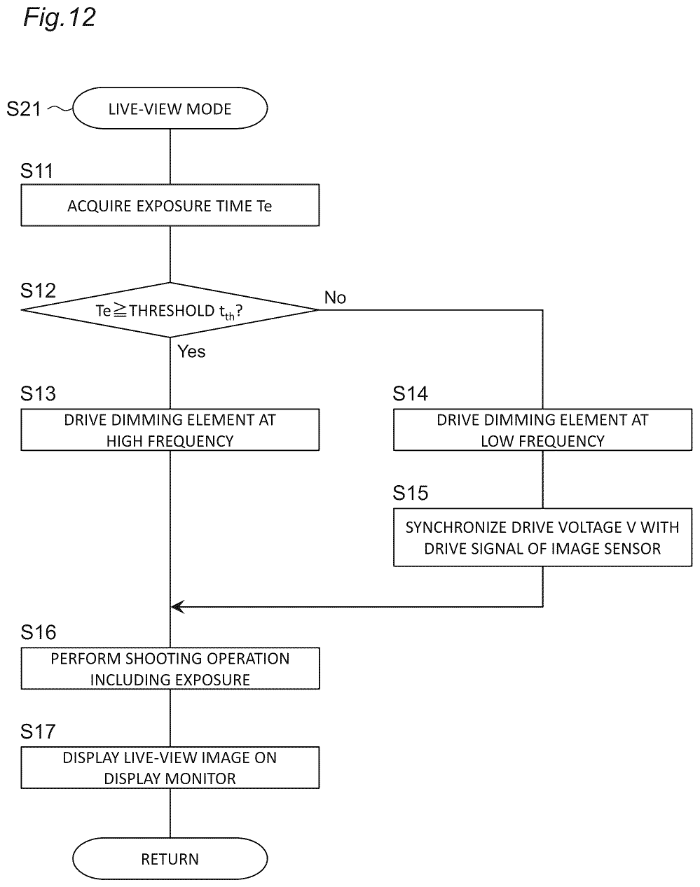

FIG. 12 is a flowchart illustrating processing in the live-view mode S21. Steps S11 to S16 in FIG. 12 are similar to steps S11 to S16 in FIG. 10, and thus description thereof is omitted. In step S17 in FIG. 12, the controller 135 displays the live-view image on the display monitor 130.

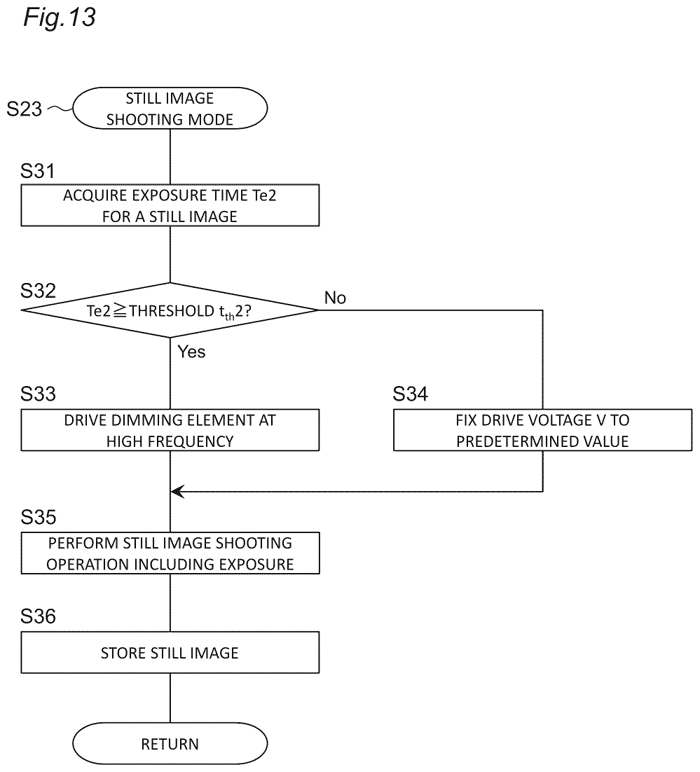

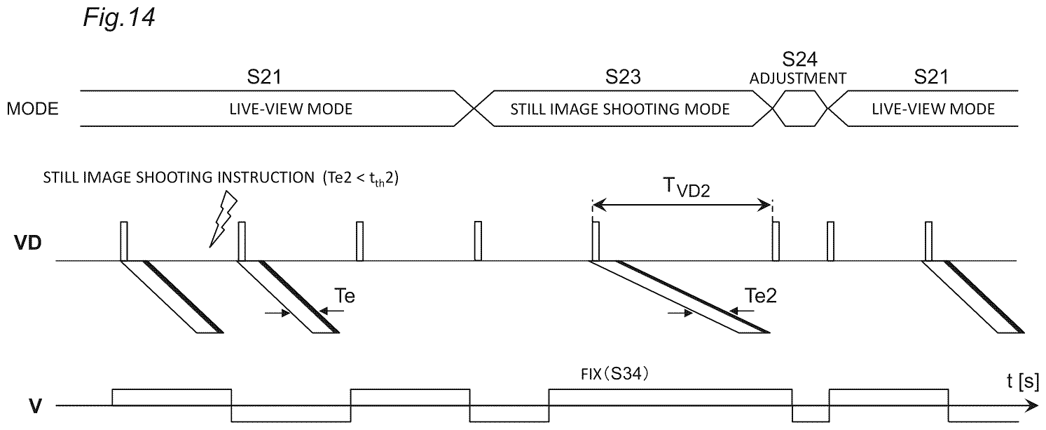

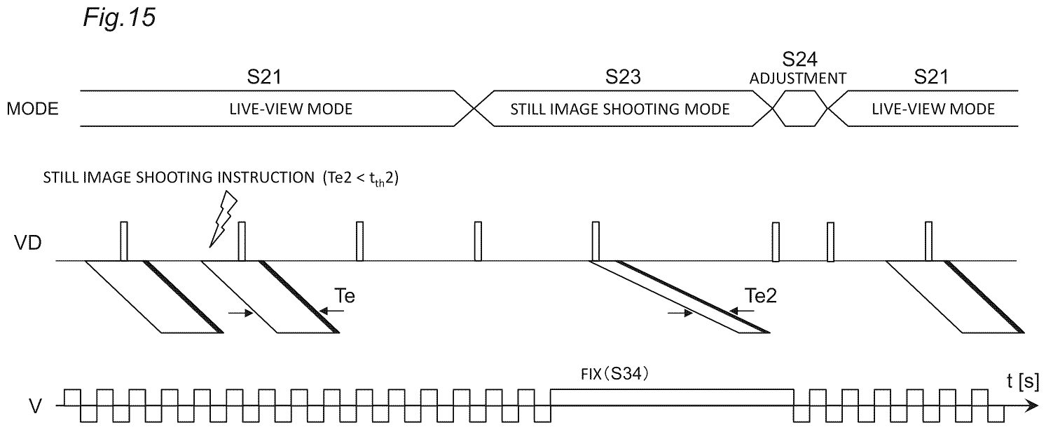

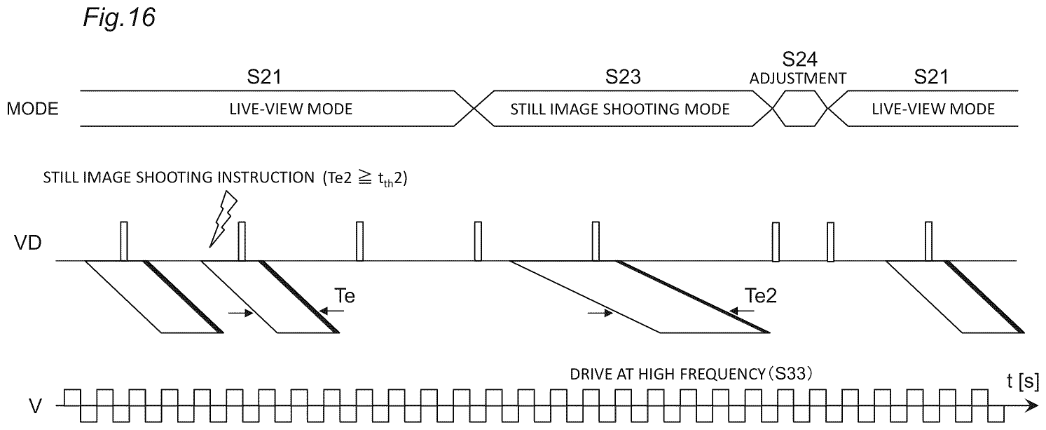

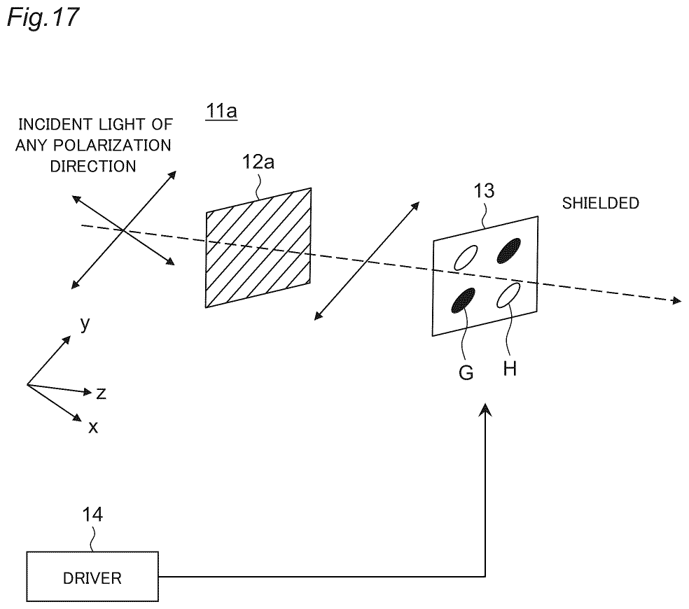

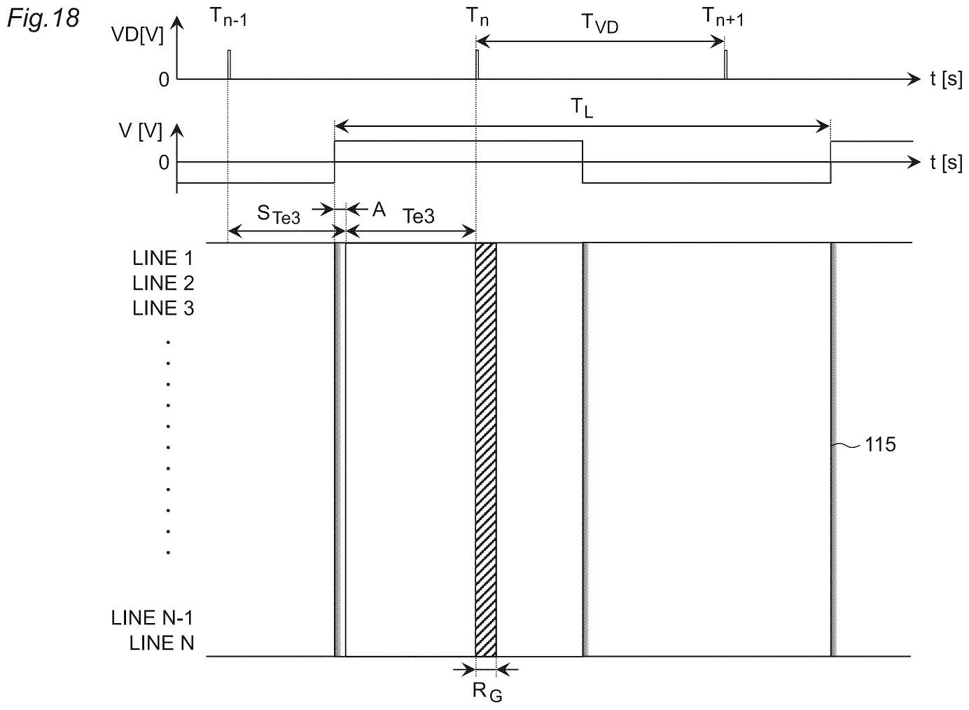

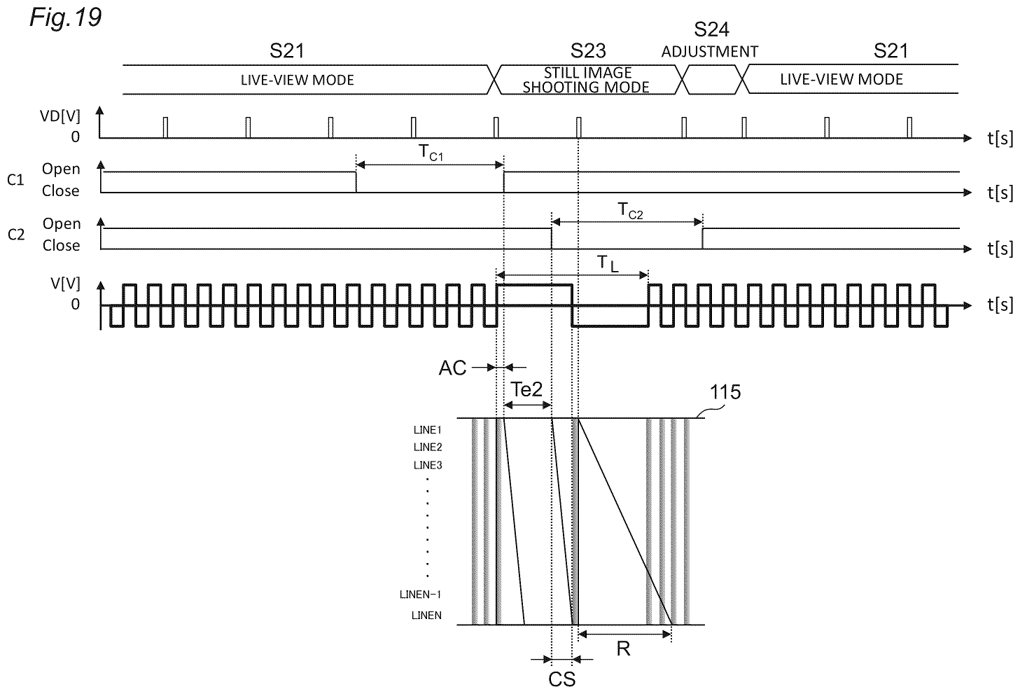

FIG. 13 is a flowchart illustrating processing in the still image shooting mode S23.

First, the controller 135 acquires an exposure time Te2 for a still image (S31). For example, the controller 135 sets the exposure time Te2 based on the user's selection using the operation member 150. Alternatively, the controller 135 may set the exposure time Te2 according to an environment such as ambient brightness.

Next, the controller 135 determines whether the exposure time Te2 is equal to or longer than the time threshold tₜₕ2 (S32). The time threshold value tₜₕ2 may be the same as or different from the time threshold value tₜₕ in FIG. 12.

When the exposure time Te2 is equal to or longer than the time threshold tₜₕ2 (Yes in S32), the controller 135 drives the dimming element 11 at a high frequency (S33).

When the exposure time Te2 is shorter than the time threshold tₜₕ2 in step S32 (No in S32), the controller 135 fixes the drive voltage V to a predetermined value (S34). Alternatively, the controller 135 may control the driver 14 so as not to invert the drive voltage V. As a result, since the drive voltage V is not inverted, the influence of the inversion of the drive voltage V on the image quality can be reduced.

After step S33 or S34, the controller 135 performs a still image shooting operation including exposure and reading (S35). In the still image shooting operation, the controller 135 may set an output time interval T_{VD} 2 of the drive signal of the image sensor 115 (see FIG. 14 to be described later) to be longer than the sum of the read time R and the exposure time Te2 of the image sensor 115. As a result, it is possible to reduce the possibility that the exposure time or the read time overlaps with the timing of inversion of the drive voltage V.

Next, the controller 135 stores the still image data generated by the image sensor 115 and the image processor 120 in the memory card 142, the flash memory 145, or the like (S36).

FIGS. 14 to 16 are timing charts for explaining control of the drive voltage V in the dimming processing according to the second embodiment.

FIGS. 14 and 15 are timing charts in a case where the exposure time Te2 is shorter than the time threshold tₜₕ2 (in a case of No in S32 in FIG. 13). FIG. 14 illustrates the case of low-frequency driving in the live-view mode S21 (in a case of No in S12 in FIG. 12). When a still image shooting instruction is issued during the live-view mode S21, the mode of the dimming apparatus 10 shifts to the still image shooting mode S23 after a predetermined period. FIG. 15 illustrates a case of high-frequency driving in the live-view mode S21 (in a case of Yes in S12 in FIG. 12). In FIGS. 14 and 15, since the exposure time Te2 is shorter than the time threshold tₜₕ2, the drive voltage V is fixed to a predetermined value in the still image shooting mode S23 (S34).

FIG. 16 is a timing chart in a case where the exposure time Te2 is equal to or longer than the time threshold tₜₕ2 (in a case of Yes in S32 in FIG. 13). In this case, the drive voltage V is driven at a high frequency (S33). As a result, the influence of the AC drive voltage V on the image quality can be reduced.

Note that, since the live-view image is not displayed on the display monitor 130 even if the live-view image is generated immediately before the shifting, the controller 135 may not generate the live-view image immediately before the shifting as illustrated in FIGS. 14 to 16.

### 3. Other Embodiments

As described above, the embodiments have been described as an example of the technology in the present disclosure. However, the technology in the present disclosure is not limited thereto, and can also be applied to embodiments in which changes, substitutions, additions, omissions, and the like are made as appropriate. In addition, each component described in the embodiments can be combined to make a new embodiment. Thus, in the following, other embodiments will be exemplified.

### 3-1. First Modification

In the first embodiment described above, the configuration (normally black) in which the liquid crystal elements 12 and 13 shield incident light in a state where the drive voltage V is not applied has been described. However, the liquid crystal element of the present disclosure is not limited thereto, and may have a configuration (normally white) in which the transmittance of the incident light is maximized in a state where the drive voltage V is not applied, and the incident light is shielded in a state where the drive voltage V is applied.

### 3-2. Second Modification

In the first embodiment described above, the dimming element 11 including the two liquid crystal elements 12 and 13 has been described, but the configuration of the dimming element of the present disclosure is not limited thereto. FIG. 17 is a schematic view illustrating a configuration of a dimming element 11a according to a second modification. The dimming element 11a in FIG. 17 includes a polarizing plate 12a that allows only incident light polarized in the y direction to pass, instead of the dimming element 11 in FIGS. 2 and 3 including the liquid crystal element 12. When the driver 14 does not apply the drive voltage V, the y-polarized light transmitted through the polarizing plate 12a is shielded by the dichroic dye molecules G of the liquid crystal element 13 aligned in the y direction, and cannot be transmitted through the liquid crystal element 13. Therefore, in the dimming element 11a according to the second modification, similarly to the first embodiment, the incident light is shielded by the dimming element 11a and the liquid crystal element 13 in a state where the drive voltage V is not applied, and the transmittance of the incident light is maximized (normally black) in a state where the drive voltage V is applied.

### 3-3. Third Modification

In the first embodiment described above, an example has been described in which the high-frequency driving is performed (S13) when the exposure time Te is equal to or longer than the time threshold tₜₕ (Yes in S12), and the low-frequency driving is performed (S14) when the exposure time Te is shorter than the time threshold tₜₕ (No in S12). However, the dimming method of the present disclosure is not limited to switching the drive frequency of the drive voltage V in two stages as described above. For example, the controller 135 may switch the drive frequency of the drive voltage V in multiple stages of three or more stages according to the length of the preset exposure time Te. In this case, the controller 135 increases the drive frequency of the drive voltage V as the exposure time Te is longer.

### 3-4. Fourth Modification

In the first embodiment described above, the dimming apparatus 10 applicable to the rolling shutter shooting method has been described, but the dimming apparatus of the present disclosure is also applicable to a global shutter shooting method.

FIG. 18 is a schematic diagram for explaining a relationship between an exposure time Te3 and a timing of inversion of the drive voltage V for each line of an image sensor 115 of a global shutter method according to a fourth modification.

Similarly to the first embodiment, when the exposure time Te3 is shorter than the time threshold tₜₕ, the controller 135 drives the dimming element 11 at a low frequency. In this case, as illustrated in FIG. 18, the controller 135 synchronizes the drive voltage V with the drive signal of the image sensor 115. When the output time interval T_{VD} of the vertical synchronization signal VD is longer than the sum of the exposure time Te3, a read time RG of the image sensor 115, and the preceding time A, the exposure time Te3 or the read time RG and the timing of inversion of the drive voltage V do not overlap with each other. Therefore, the influence of the AC drive voltage V on the image quality can be reduced.

### 3-5. Fifth Modification

In the second embodiment described above, an example has been described in which when the exposure time Te2 is shorter than the time threshold tₜₕ2 (No in S32), the drive voltage V is fixed to a predetermined value (S34). However, the operation performed in the case of No in step S32 is not limited thereto. For example, in the case of No in step S32, the controller 135 may drive the dimming element 11 at a low frequency and synchronize the drive voltage V with the drive signal of the image sensor 115, similarly to steps S14 and S15 in FIG. 12. As a result, it is possible to reduce the possibility that the exposure time or the read time R overlaps with the timing of inversion of the drive voltage V.

### 3-6. Sixth Modification

In the second embodiment described above, an example in which the live-view mode and the still image shooting mode are switched has been described. However, the mode switching is not limited thereto, and the controller 135 may be capable of switching between the live-view mode and the moving image shooting mode. In a case where the live-view mode is shifted to the moving image shooting mode, in the moving image shooting mode, the controller 135 may change the drive frequency of the dimming element according to the exposure time. For example, in the moving image shooting mode, the controller 135 may execute processing similar to S11 to S16 in FIG. 12.

Furthermore, the controller 135 may be capable of switching among three modes of a live-view mode, a still image shooting mode, and a moving image shooting mode.

### 3-7. Seventh Modification

In the first embodiment described above, an example has been described in which the electronic shutter of the image sensor 115 is used in the still image shooting mode. However, the shutter method is not limited thereto, and a light shielding element may be used. A shutter of the optical system 110, that is, a lens shutter may be used as a light shielding element, or a focal plane shutter may be installed between the dimming element 10 and the image sensor 115 and used as the light shielding element. In addition, an electronic front curtain shutter using both a focal plane shutter and an electronic shutter may be used.

FIG. 19 is a schematic diagram for explaining the relationship between the exposure time Te2 and the timing of inversion of the drive voltage V for each line of the image sensor 115 of a method using the focal plane shutter according to the seventh modification as the light shielding element. A section in which both a front curtain C1 and a rear curtain C2 of the focal plane shutter are open is the exposure time Te2. Here, a case where the exposure time Te2 is shorter than the time threshold tₜₕ2 (No in S32) is illustrated.

The focal plane shutter shields incident light to the image sensor 115 in a section TC1 in which the front curtain C1 is closed and a section TC2 in which the rear curtain C2 is closed. As illustrated in FIG. 19, the controller 135 performs synchronization such that a section in which both the front curtain C1 and the rear curtain C2 are open falls within an output time interval T_{VD} of the image sensor 115. Furthermore, as illustrated in FIG. 19, the controller 135 synchronizes the drive voltage V with the front curtain C1 and the rear curtain C2 of the focal plane shutter. Even if the read time R and the timing of inversion of the drive voltage V overlap with each other, the image sensor 115 does not expose light because the light is shielded by the rear curtain C2. When T_{L}/2 is longer than the sum of the exposure time Te2, a curtain speed CS, and a preceding time AC, the exposure time Te2 does not overlap with the timing of inversion of the drive voltage V. Therefore, the influence of the AC drive voltage V on the image quality can be reduced.

As described above, in the seventh modification, the controller 135 synchronizes the drive voltage V with the timing of light shielding by the front curtain C1 and the rear curtain C2, which are an example of the light shielding element. The controller 135 may change the drive voltage V while causing the front curtain C1 or the rear curtain C2 to shield light.

Alternatively, the controller 135 may fix the drive voltage V to a predetermined value for a time including the exposure time Te2 (S34).

Alternatively, the drive voltage V may be synchronized with the drive signal of the image sensor 115.

### 4. Example of Aspects

Hereinafter, various aspects according to the present disclosure will be listed.

A first aspect according to the present disclosure provides a dimming apparatus comprising:
a dimming element that adjusts an amount of light reaching an imaging element from a subject at a time of imaging according to an applied voltage;
a driver that applies a drive voltage to be inverted to the dimming element; and
a controller that controls the driver,
wherein the controller controls the driver to change a drive frequency of the drive voltage according to a preset length of an exposure time of the imaging element.

According to a second aspect, in the dimming apparatus according to the first aspect, the controller increases the drive frequency as the exposure time is longer.

According to a third aspect, in the dimming apparatus according to the first or second aspect, the controller sets a drive frequency of the drive voltage to be higher than a predetermined frequency when the exposure time is equal to or longer than a predetermined time, and sets the drive frequency to the predetermined frequency or less when the exposure time is shorter than the predetermined time.

According to a fourth aspect, in the dimming apparatus according to any one of the first to third aspects, the controller synchronizes the drive voltage with a drive signal of the imaging element.

According to a fifth aspect, in the dimming apparatus according to the fourth aspect, the controller changes the drive voltage before or after a predetermined time of a change in the drive signal of the imaging element.

According to a sixth aspect, the dimming apparatus according to any one of the first to fifth aspects further includes a light shielding element that shields light reaching the imaging element from the subject at the time of imaging. The controller synchronizes the drive voltage with a timing of light shielding by the light shielding element.

According to a seventh aspect, the dimming apparatus according to any one of the first to sixth aspects further includes a light shielding element that shields light reaching the imaging element from the subject at the time of imaging. The controller controls a timing of shielding of the light by the light shielding element and changes the drive voltage while the light shielding element shields the light.

According to a eighth aspect, in the dimming apparatus according to the forth or fifth aspect, the controller sets an output time interval of a drive signal of the imaging element to be longer than a sum of a read time and the exposure time of the imaging element.

According to a ninth aspect, in the dimming apparatus according to any one of the first to eighth aspects, the controller determines an exposure time for a moving image and an exposure time for a still image, and changes a drive frequency of the drive voltage according to a length of the exposure time for a moving image at a time of shooting a moving image. The controller sets the drive frequency of the drive voltage to be higher than a predetermined frequency when the exposure time for a still image is equal to or longer than a predetermined time at a time of shooting a still image, and does not invert the drive voltage when the exposure time for a still image is shorter than the predetermined time.

According to a tenth aspect, in the dimming apparatus according to any one of the first to ninth aspects, the dimming element includes a liquid crystal element that adjusts an amount of transmitted light according to an applied voltage.

An eleventh aspect according to the present disclosure provides an imaging apparatus including the dimming apparatus according to any one of the first to tenth aspects, and an imaging element that captures an image of a subject to generate image data.

The concept of the present disclosure can be applied to a dimming apparatus and an imaging apparatus including the dimming apparatus.

What is claimed is:

1. A dimming apparatus comprising:
a dimming element that adjusts an amount of light reaching an imaging element from a subject at a time of imaging according to an applied voltage;
a driver that applies a drive voltage to be inverted to the dimming element; and
a controller that controls the driver,
wherein the controller controls the driver to change a drive frequency of the drive voltage according to a preset length of an exposure time of the imaging element.

2. The dimming apparatus according to claim 1, wherein the controller increases the drive frequency as the exposure time is longer.

3. The dimming apparatus according to claim 1, wherein the controller
sets a drive frequency of the drive voltage to be higher than a predetermined frequency when the exposure time is equal to or longer than a predetermined time, and
sets the drive frequency to the predetermined frequency or less when the exposure time is shorter than the predetermined time.

4. The dimming apparatus according to claim 1, wherein the controller synchronizes the drive voltage with a drive signal of the imaging element.

5. The dimming apparatus according to claim 4, wherein the controller changes the drive voltage before or after a predetermined time of a change in the drive signal of the imaging element.

6. The dimming apparatus according to claim 1, further comprising a light shielding element that shields light reaching the imaging element from the subject at the time of imaging,
wherein the controller synchronizes the drive voltage with a timing of light shielding by the light shielding element.

7. The dimming apparatus according to claim 1, further comprising a light shielding element that shields light reaching the imaging element from the subject at the time of imaging,
wherein the controller
controls a timing of shielding of the light by the light shielding element, and
changes the drive voltage while the light shielding element shields the light.

8. The dimming apparatus according to claim 4, wherein the controller sets an output time interval of a drive signal of the imaging element to be longer than a sum of a read time and the exposure time of the imaging element.

9. The dimming apparatus according to claim 1,
wherein the controller
determines an exposure time for a moving image and an exposure time for a still image,
changes a drive frequency of the drive voltage according to a length of the exposure time for a moving image at a time of shooting a moving image,
sets the drive frequency of the drive voltage to be higher than a predetermined frequency when the exposure time for a still image is equal to or longer than a predetermined time at a time of shooting a still image, and
does not invert the drive voltage when the exposure time for a still image is shorter than the predetermined time.

10. The dimming apparatus according to claim 1, wherein the dimming element includes a liquid crystal element that adjusts an amount of transmitted light according to an applied voltage.

11. An imaging apparatus comprising:
the dimming apparatus according to claim 1; and
an imaging element that captures an image of a subject to generate image data.
